(19) United States
(12) Patent Application Publication
(10) Pub. No.: US 2005/0031222 A1
(43) Pub. Date: Feb. 10, 2005

(54) Filter kernel generation by treating algorithms as block-shift invariant

(76) Inventor: Yacov Hel-Or, Zichron Yacov (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/638,755

(22) Filed: Aug. 9, 2003

(51) Int. Cl. G06K 9/40

(52) U.S. Cl. 382/260

(57) ABSTRACT

Filter kernels for an image processing algorithm are generated by treating the algorithm as block shift-invariant. The image processing algorithm may be a demosaicing algorithm. Demosaicing of a mosaic image may be performed by convolving filter kernels with pixel values of the mosaic image.

### BACKGROUND

Certain digital cameras have only a single photosensor at each pixel location, with each photosensor sensitive to only a single color. These cameras produce digital images that are have less than full color information at each pixel. For example, each pixel provides only one of red, green and blue information. These undersampled digital images are referred to as “mosaic” images.

A demosaicing algorithm may be used to transform an undersampled digital image into a digital image having full color information at each pixel value. A typical demosaicing algorithm interpolates missing pixel information. Some demosaicing algorithms use bilinear or bi-cubic interpolation.

Any demosaicing algorithm that is linear and non-adaptive can be implemented as a set of filter kernels. The filter kernels may be applied to the undersampled image by an on-board processor of the digital camera.

In many instances the demosaicing is described in an algorithmic manner, especially when the demosaicing algorithm is iterative. In such instances, finding the filter kernels is complicated and involves specific mathematical derivations.

Moreover, each mathematical derivation is algorithm-dependent. The algorithms cannot be treated as black boxes. Thus a specific derivation is made for each given algorithm.

### SUMMARY

According to one aspect of the present invention, filter kernels for an image processing algorithm are generated by treating the algorithm as block shift-invariant. According to another aspect of the present invention, demosaicing of a mosaic image is performed by convolving the filter kernels with pixel values of the mosaic image.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIGS. 1a-1d are illustrations of responses to impulse inputs by a linear-shift invariant algorithm.

FIG. 2 is an illustration of an exemplary photosensor arrangement for a CCD, and a resulting mosaic image.

FIGS. 3a-3d are illustrations of responses to impulse inputs by a block-shift invariant algorithm.

FIG. 4 is an illustration of a signal domain of a digital imaging system.

FIGS. 5a-5d are illustrations of a method of generating filter kernels in accordance with an embodiment of the present invention.

FIG. 6 is an illustration of a method of generating filter kernels for the CCD of FIG. 2.

FIG. 7 is an illustration of a method of using the filter kernels in accordance with an embodiment of the present invention.

FIG. 8 is an illustration of a digital imaging system in accordance with an embodiment of the present invention.

FIG. 9 is an illustration of a machine for generating filter kernels in accordance with an embodiment of the present invention.

FIGS. 10-11 are illustrations of exemplary kernels generated in accordance with an embodiment of the present invention.

### DETAILED DESCRIPTION

The present invention is embodied in the generation of filter kernels for linear non-adaptive demosaicing algorithms. The filter kernels are generated by treating the linear algorithms as block-shift invariant. Treating an algorithm as such is a simplification that allows the filter kernels to be generated without a detailed knowledge of the algorithm. As a result, the algorithm can be treated as a black box. Moreover, the filter kernels can be generated for a variety of different linear demosaicing algorithms.

The present invention is also embodied in the demosaicing of mosaic images. The demosaicing, which involves interpolating missing pixel values in the mosaic images (e.g., images generated by digital cameras), can be performed efficiently by convolving the filter kernels with pixel values of the mosaic image. This greatly reduces run time, especially when the convolution is implemented in hardware (e.g., a digital camera) or in a computer using a Fast Fourier Transform.

The generation of filter kernels and the demosaicing of mosaic images are described in detail below. First, however, several terms are defined. Initially, the definitions are expressed for one-dimensional signals. Then the definitions will be expanded to higher dimensional signals.

An algorithm may be regarded as “linear” if:
A{λD₁(x)}=λA({D₁(x)}
A{D₁(x)+D₂(x)}=A{D₁(x)}+A{D₂(x)}
where D₁(x) and D₂(x) represent signal inputs to the algorithm, x is an input coordinate, and A{ } represents the response of the algorithm.

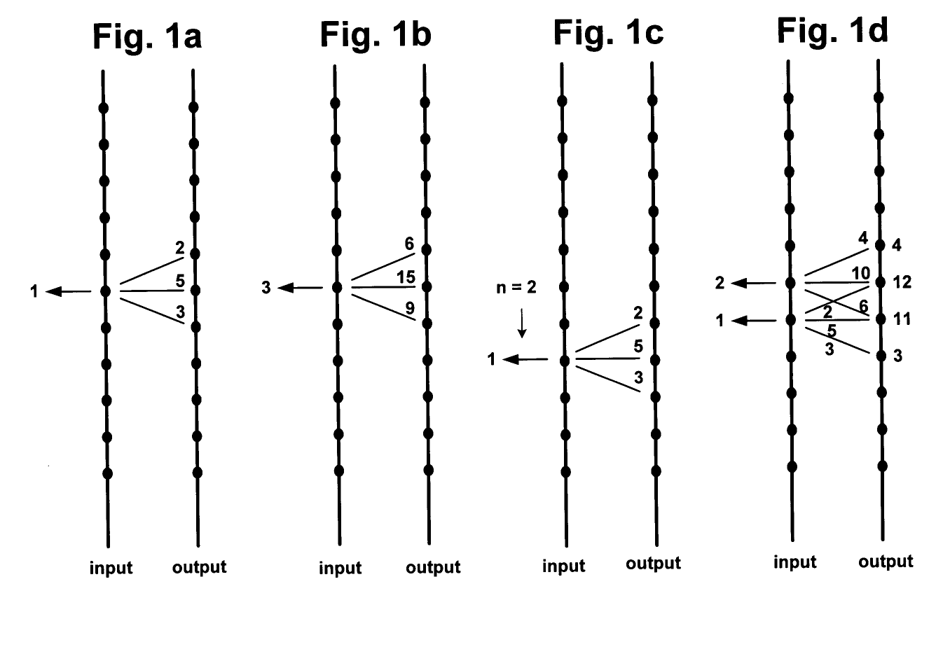

An algorithm may be regarded as “linear shift-invariant” if it is linear and satisfies the following condition:
A{D(x+n)}(y)=A({D(x)}(y+n)
where x is the input coordinate, y is the output coordinate, and n is an integer that represents the input shift. Responses to impulse inputs by a linear-shift invariant system are illustrated in FIGS. 1a-1d.

FIG. 1a illustrates an impulse input (signal of value “1”) to a first input position, and the algorithm responses (values “2”, “5” and “3”) at output positions. FIG. 1b illustrates that multiplying the input signal by a scale factor (e.g., by a factor of “3”) causes the responses to be multiplied by the same scale factor (due to linearity). FIG. 1c illustrates that applying the same input to a second input position, which is shifted by n=2 from the first position, will result in a similar response, except that the response is also shifted by n=2 (due to shift-invariance).

FIG. 1d illustrates the responses to a more complicated input. This response can be predicted using the linear shift-invariant properties. Each output position is the sum of the responses to the individual impulse inputs.

Knowing the response of a shift-invariant linear algorithm to a single impulse input is enough to predict the response of the algorithm to any given input or set of inputs. The system impulse response serves also as a filter kernel which, when applied to a signal input, gives the response to the signal input.

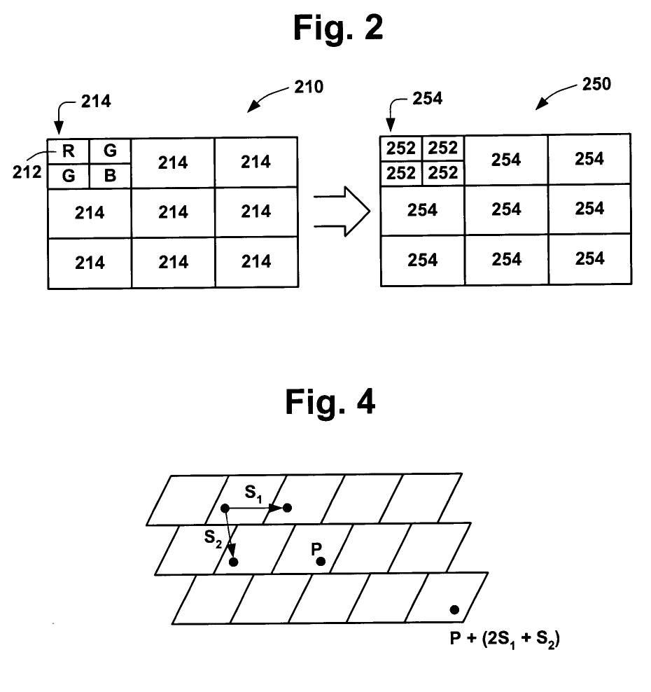

A demosaicing algorithm for a photosensor array can be treated as “shift-invariant” when the locations of the photosensor array are homogeneous, i.e. there is no distinction between different photosensors. If, however, different locations have different types of sensors (different colors at different locations), the algorithm cannot be so-treated. For example, a photosensor array 210 shown in FIG. 2 includes photosensors 212 arranged in 2×2 cells 214. Each cell 214 consists of two photosensors providing green (G) data only, one photosensor providing red (R) data only, and one photosensor providing blue (B) data only. The cells 214 are repeated (tiled) across the array 210. This photosensor arrangement is referred to as the Bayer color filter array (CFA).

A demosaicing algorithm for the photosensor array 210 shown in FIG. 2 would not be treated as shift-invariant for any integer n. However, the algorithm could be treated as “block-shift invariant.”

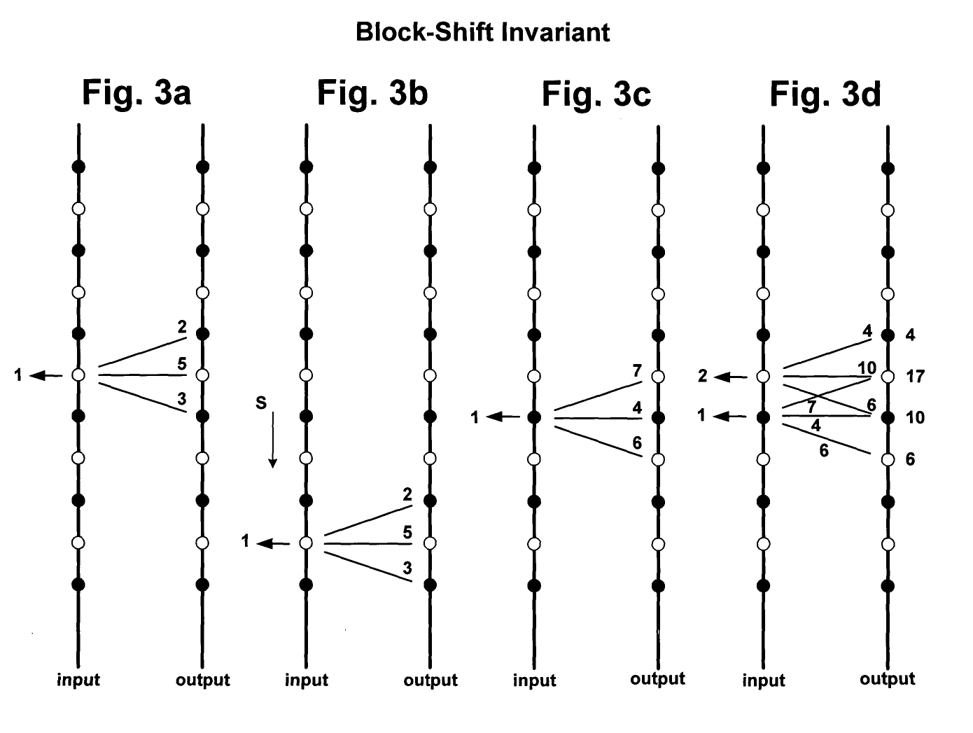

In the one-dimensional case, an algorithm may be regarded as block-shift invariant if
A{D(x−n s}(y)=A{D(x)}(y−n s)
where x represents input coordinates, y represents output coordinates, n is an integer that represents the input shift, and s is a fixed number representing a block width. Thus, the algorithm can be treated as shift invariant only for shifts by multiples of s. Responses to impulse inputs by a block-shift invariant algorithm are illustrated in FIGS. 3a-3d.

In the example shown in FIGS. 3a-3d, a block size has a width of s=2. An input provides the same responses for pixels that are in similar neighborhoods (far apart by n*s) as shown in FIGS. 3a and 3b). The impulse input provides a different response when applied to an input position that has a different neighborhood (FIG. 3c). Thus shifting the impulse input by an integer number of blocks causes the response to be shifted by the same integer number of shifts, i.e. A{D(x−2n}(y)=A{D(x)}(y−2n). ). In such a case, knowing the responses of impulse inputs for all possible input types is enough to predict the system response for any possible input signal (FIG. 3d).

The following is an extension of block-shift invariance for two-dimensional signals:
A{D(x−ms₁−ns₂}(y)=A{D(x)}(y−ms₁−ns₂) for any integer numbers m and n,
where x is a 2-D vector representing the input coordinates, y is a 2-D vector representing the output coordinates, (m,n) represents the input shift, and (s₁,s₂) are two 2-D vectors representing permissible shifts from block to block (see FIG. 4).

Reference is now made to FIG. 4, which illustrates a signal domain of a digital imaging system. In a block-shift invariant system, the entire signal domain is tiled by a collection of blocks having similar shapes. A canonical block consists of N indexed grid positions p₁, . . . , p_{N}. The function g(p) maps a general grid position p to its canonical position index. That is, g(p)ε{1, . . . , N}, and in particular, for the canonical block g(pᵢ)=i. For example, g(p)=g(p+mS₁+nS₂) for any integers m and n.

When a linear block-shift invariant algorithm A{ } is applied to an impulse input δ located at position p, the following output response results:
A{(δ(x−p)}(y)=Rₚ(y)
where δ(x−p)=1 for x=p and δ(x−p)=0 otherwise.

For two locations p and q which satisfy g(p)=g(q)
Rₚ(y+p)=R_{q}(y+q)=\hat{R}_{g(p)}(y)
which is an outcome of the block-shift invariance property.

Applying the algorithm to N different impulse input signals (at N different location indices) results in a set of N different impulse responses \hat{R}ᵢ(y),i=1, . . . N, where \hat{R}ᵢ(y)=Rₚ(y+pᵢ) where g(pᵢ)=i.

Given this set of N impulse responses, the algorithm response to any shifted impulse can be deduced:
A{(δ(x−k)}(y)=\hat{R}_{g(k)}(y−k)

For any given input signal Sᵢₙ(x), an output signal Sₒᵤₜ(x) can be calculated from the set of \hat{R}ᵢ(y) as

$$\begin{matrix}{s}_{out} ( y ) = A \{ {s}_{in} ( x ) \} ( y ) \\ = A \{ {\sum }_{k} δ ( x - k ) {s}_{in} ( k ) \} ( y ) \\ = {\sum }_{k} {s}_{in} ( k ) A \{ δ ( x - k ) \} ( y ) \\ = {\sum }_{k} {s}_{in} ( k ) {\hat{R}}_{g ( k )} ( y - k ) \\ = {\sum }_{k} {s}_{in} ( y - k ) {\hat{R}}_{g ( y - k )} ( k )\end{matrix}$$

Thus, the output of a linear block-shift invariant algorithm to any input signal can be characterized entirely by the set of impulse responses \hat{R}ᵢ(k).

A set of N convolution kernels Hᵢ(k),i=1, . . . , N can be constructed, where H_{g(y)}(k)=\hat{R}_{g(y-k)}(k). Now for any given input signal Sᵢₙ(x), an output signal Sₒᵤₜ(x) can be calculated from the set of N kernels Hᵢ(k) as

$${s}_{out} ( y ) = {\sum }_{k} {s}_{in} ( y - k ) {H}_{g ( y )} ( k ) .$$

Two examples of generating block-shift invariant filter kernels will now be provided. The first example involves an imaging system including a one-dimensional photosensor array having two different types of photosensors located in alternating positions. Thus the block size equals two. In this example there is only a single 1-D output array. The second example involves a Bayer CFA and three output color planes. The filter kernels are generated from a linear demosaicing algorithm. The linear demosaicing algorithm is not limited to any particular algorithm.

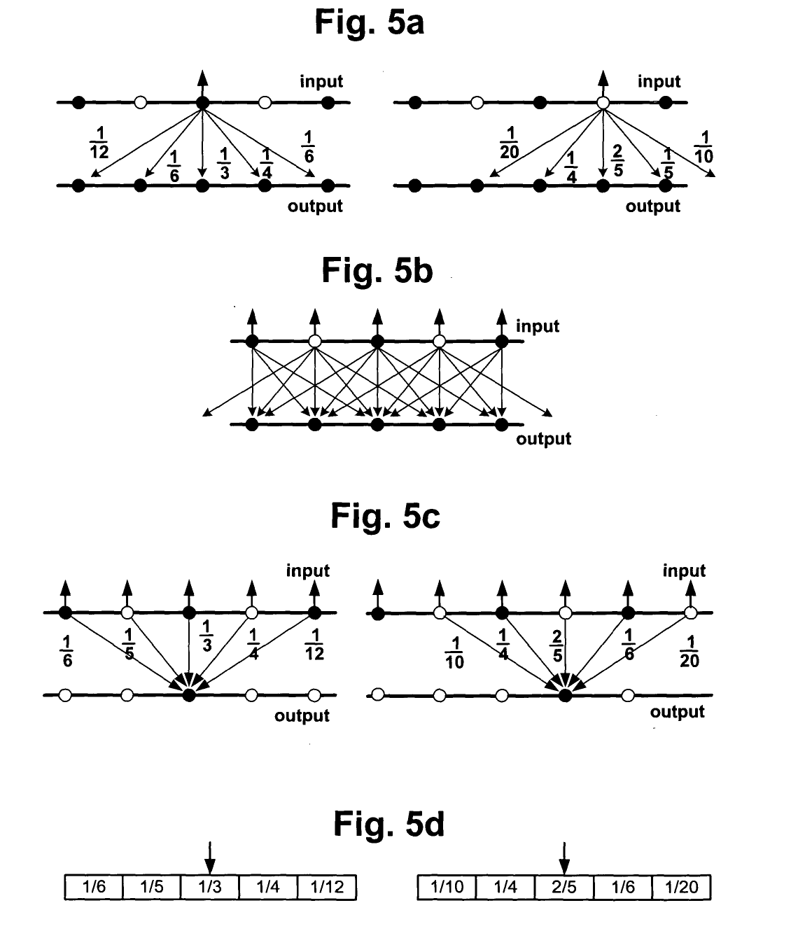

Reference is made to FIGS. 5a-5d, which illustrate the method of generating filter kernels for the one-dimensional array of photosensors. Since the block size equals two, and only a single output array is considered, a total of two kernels will be generated. Two impulse inputs are applied at two different location indices, as elaborated, resulting in two impulse responses: \hat{R}ᵢ(y), i=1,2 (FIG. 5a). Since the algorithm is block-shift invariant, there will be two different responses at the output positions. From the above two responses, the algorithm response for any possible impulse inputs can be calculated (FIG. 5b). These responses are used to construct two filter kernels Hᵢ(k), i=1,2. FIG. 5c shows the contribution of each input position to a particular output position as calculated from the two impulse responses. FIG. 5d are the two filter kernels H₁(k) and H₂(k) (for two different type of output locations) that were generated from the two impulse responses.

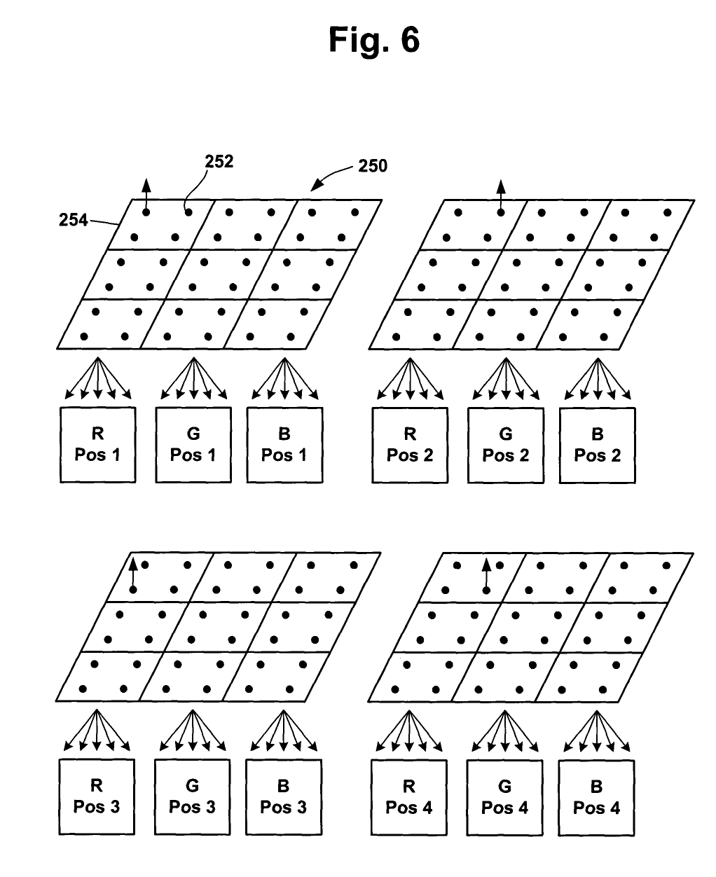

The second example will now be described. Reference is made to FIG. 6, which illustrates a mosaic image 250 produced by a Bayer CFA. Each pixel 252 of the mosaic image 250 provides one of red, green and blue color information. In each 2×2 block 254 of the mosaic image 250, two pixels provide green information, one pixel provides red information, and one pixel provides blue information.

A cell is selected, and the steps illustrated in FIGS. 5a-5d are performed on each pixel of the selected cell. Since there are four different pixels per cell, a total of four kernels per color plane are generated. Since there are three color planes per cell, a total of twelve kernels are generated for a cell: kernels R_{Pos1}, R_{Pos2}, R_{Pos3} and R_{Pos4} for the red color plane; G_{Pos1}, G_{Pos2}, G_{Pos3} and G_{Pos4} for the green color plane; and B_{Pos1}, B_{Pos2}, B_{Pos3} and B_{Pos4} for the blue color plane.

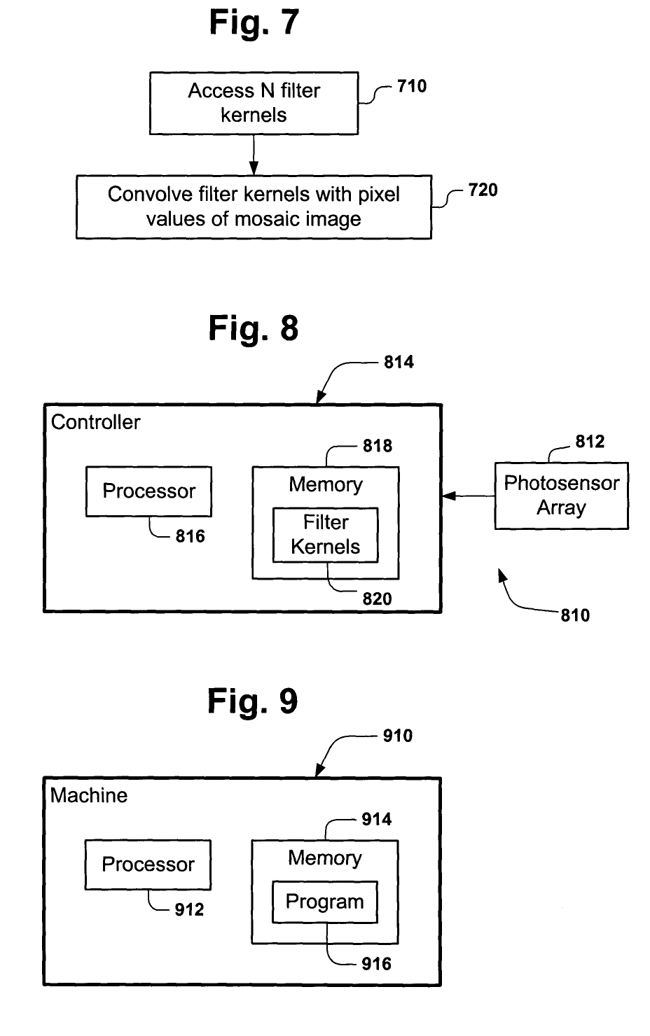

Reference is now made to FIG. 7, which illustrates a method of using the filter kernels on a mosaic image. There are N kernels for each cell (710). Each kernel corresponds to a pixel of the cell.

The same set of N kernels is applied to each block of the mosaic image (720). The mosaic image is determined by convolving the corresponding kernel with all of the pixel values at the same position index.

An exemplary hardware implementation of this method is illustrated in FIG. 8. A digital imaging system 810 includes a photosensor array 812 such as a CCD. The photosensors of the array 812 may be arranged in a Bayer CFA. The array 812 generates an undersampled digital image.

The digital imaging system 810 also includes a controller 814 for, among other things, transforming the undersampled image into an image having full color information at each pixel. The controller 814 includes a processor 816 and memory 818. The memory 818 stores the filter kernels 820. The controller 814 may have dedicated circuitry for performing convolution with the filter kernels 820, or the processor 816 may perform the convolution using a FFT.

If the digital imaging system 810 is a digital camera, the controller 814 may be on-board. However, the system 810 is not so limited. For example, the undersampled digital image may be generated by a digital camera, scanner or other capture device, and the processing is performed on a separate machine, such as a personal computer.

Reference is now made to FIG. 9, which illustrates a machine 910 for generating the filter kernels. The machine 910, which may be a personal computer, includes a processor 912 and memory 914. Stored in the memory 914 is a program 916 for causing the processor 912 to generate the filter kernels according to the method above.

As mentioned above, the present invention is not limited to any particular demosaicing algorithm. Thus the present invention is not limited to bilinear interpolation, which will now be considered in an example of filter kernel generation according to the present invention.

Assume a mosaic image m(i,j) for i,j=1,2, . . . is given according to the Bayer sampling arrangement shown in FIG. 2. A first approximation with respect to the full color image can be obtained using bilinear interpolation. Consider the following algorithm for bilinear interpolation.

```
Function [r,g,b]=bilinear_demosaic(m)
for i=1:N % scan rows
  for j=1:M % scan cols
    if even(i) & odd(j)
      r(i,j)=(r(i+1,j)+r(i−1,j))/2
      b(i,j)=(b(i,j+1)+b(i,j−1))/2
    if odd(i) & odd(j)
      g(i,j)=(g(i+1,j)+g(i−1,j)+ g(i,j+1)+g(i,j−1))4
      b(i,j)=(b(i−1,j+1)+b(i−1,j−1)+ b(i+1,j+1)+b(i+1,j−1))/4
    if even(i) & even(j)
      g(i,j)=(g(i+1,j)+g(i−1,j)+ H(i,j+1)+g(i,j−1))/4
      r(i,j)=(r(i−1,j+1)+r(i−1,j−1)+ r(i+1,j+1)+r(i+1,j−1))/4
    if odd(i) & even(j)
      r(i,j)=(r(i,j+1)+r(i,j−1))/2
      b(i,j)=(b(i+1,j)+b(i−1,j))/2
  end % for j loop
end % for i loop
```

This algorithm is non-adaptive and linear and, therefore, can be treated as block-shift invariant. The algorithm is supplied as an input to a kernel generating program. The kernel generating program (1) applies impulse inputs to the algorithm, (2) obtains a set of impulse responses, and (3) generates the convolution kernels from the set of impulse responses.

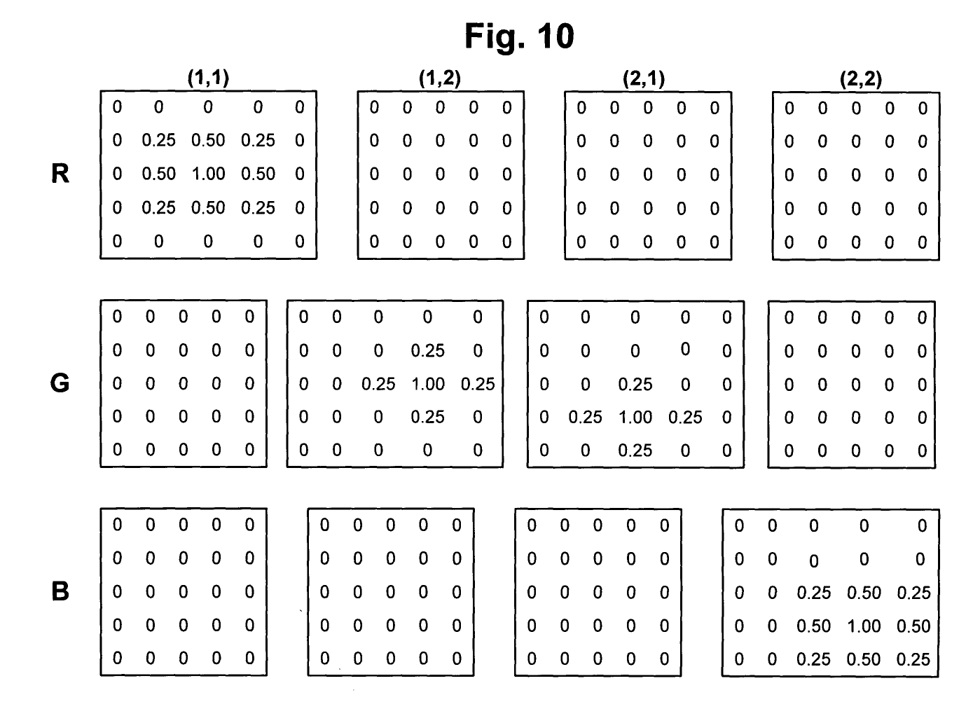

The impulse responses are illustrated in FIG. 10. Twelve windows are shown, with each window containing a 5×5 array of response values. From top to bottom, the rows correspond to the red (R), green (G), and blue (B) components. Each row has four windows corresponding to cell positions (left to right) (1,1), (1,2), (2,1), and (2,2) of the CFA. The response of a particular impulse is induced by the “contribution” of this pixel to the estimation of the color values in various surrounding locations. Note that the bilinear interpolation does not have a cross color influence; therefore, an impulse input applied to a red location influences only neighboring red locations, an impulse input applied to a green location influences only neighboring green locations, and an impulse input applied to a blue location influences only neighboring blue locations.

Given these twelve impulse responses Rᵢ(y),i=1, . . . 12, the canonical responses \hat{R}ᵢ(y),i=1, . . . 12 can be calculated. Filter kernels Hᵢ(k),i=1, . . . , N can be constructed from the canonical responses, where H_{g(y)}(k)=\hat{R}_{g(y-k)}(k).

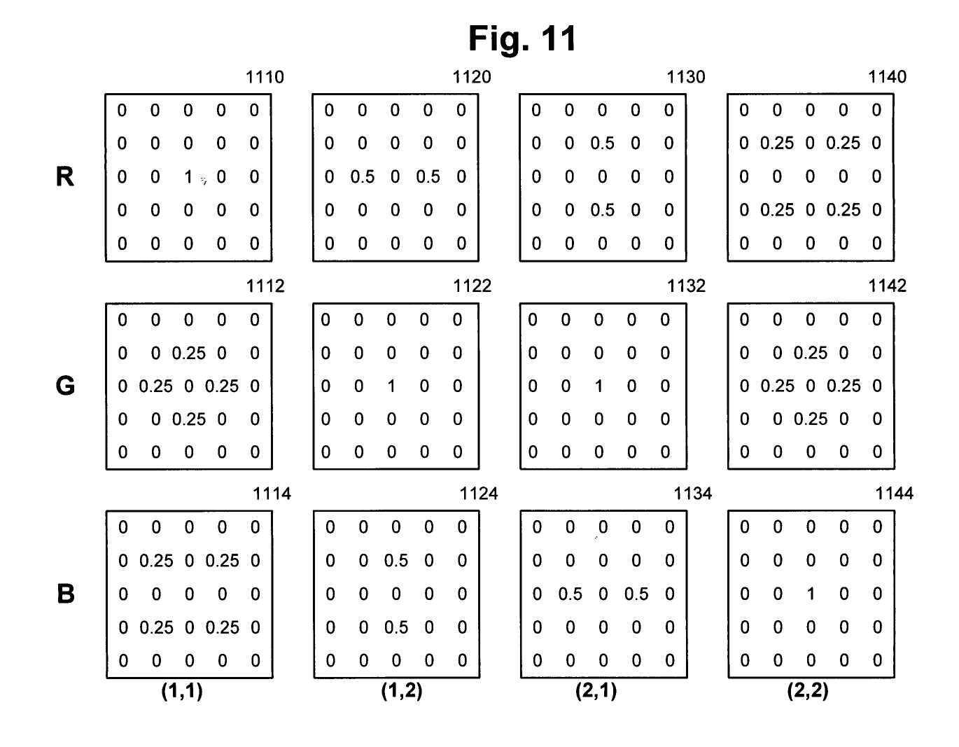

The resulting 5×5 filter kernels are illustrated in FIG. 11. Four kernels are given at each row, for block positions (left to right) (1,1), (1,2), (2,1), and (2,2) of the CFA. From top to bottom, the rows show the filter kernels for red (R), blue (B) and green (G) components.

These 5×5 filter kernels may be applied to a mosaic image having the sampling

$$[ \begin{matrix}r & g \\ g & b\end{matrix} ] .$$

The red, green and blue values for the pixel at position (1,1) can be interpolated as follows. A red value was sampled at this position (1,1). The red value for the pixel at position (1,1) is generated by applying the kernel 1110 to this pixel when the center of the kernel 1110 is at the (1,1) position. Since the pixel at position (1,1) has a red value, the red value is multiplied by a weight of 1. The green value for the pixel at position (1,1) is generated by applying the kernel 1112 when the center of the kernel 1112 is at the (1,1) position. As a result, all four neighboring values (which are green values) are multiplied by the same weight (0.25). The blue value for the pixel at position (1,1) is generated by applying the kernel 1114 when the center of the kernel 1114 is at the (1,1) position. As a result, all four neighboring values (which are blue values) are multiplied by the same weight.

The red, green and blue values for the pixel at position (1,2) can be generated as follows. A green value was sampled at this position (1,2). The red value for the pixel at position (1,2) is generated by applying the kernel 1120 to this pixel when the center of the kernel 1120 is at the (1,2) position. As a result, two neighboring red values are multiplied by the same weight. The green value for the pixel at position (1,2) is generated by applying the kernel 1122 when the center of the kernel 1122 is at the (1,2) position. Since a green value was sampled at position (1,2), the green value is multiplied by a weight of 1. The blue value for the pixel at position (1,2) is generated by applying the kernel 1124 when the center of the kernel 1124 is at the (1,2) position. As a result, two neighboring blue values are multiplied by the same weight.

The red, green and blue values for the pixel at position (2,1) can be generated by applying the filter kernels 1130, 1132 and 1134. The red, green and blue values for the pixel at position (2,2) can be generated by applying the filter kernels 1140, 1142 and 1144.

The present invention is not limited to filter kernels that only perform demosaicing. The present invention can be used to modify filter kernels to perform image processing in addition to demosaicing. Types of image processing include, without limitation, sharpening and denoising.

Consider the following example of filter kernels that perform bilinear interpolation, sharpening of the luminance component, and smoothing of the chrominance components. The following algorithm can be used for such image processing, and method above can be used to generate 5×5 filter kernels for the following algorithm.

[r,g,b]=bilinear_demosaic(m) %bilinear interpolation
[y,c1,c2]=rgb2ntsc(r,g,b) % linearly transform from RGB to NTSC color space
c1=convolve(c1,G) % convolve chroma c1 with a Gaussian kernel G
c2=convolve(c2,G) % convolve chroma c2 with a Gaussian kernel G
y=convolve(y,S) % convolve y with a sharpening kernel S
[r,g,b]=ntsc2rgb(y,c1,c2) % transform back to RGB space
[r,g,b]=resetOriginal(m) % reset original values from mosaic image m

In both examples, the algorithms are regarded as black boxes. The algorithms are supplied as inputs to a generating kernel program.

The present invention is not limited to demosaicing in two dimensions. The present invention can be used to performed demosaicing in three dimensions (e.g., time-space domain for digital video).

The present invention is not limited to the Bayer CFA, and may be used in connection with other arrangements of photosensors that produce mosaic images.

The present invention is not limited to demosaicing. The present invention can be applied to any algorithm that can be treated as block-shift invariant.

Although several specific embodiments of the present invention have been described and illustrated, the present invention is not limited to the specific forms or arrangements of parts so described and illustrated. Instead, the present invention is construed according to the claims the follow.

1. A method of generating filter kernels for an image processing algorithm, the method comprising treating the algorithm as block-shift invariant.

2. The method of claim 1, wherein the block-shift invariant algorithm is characterized by a set of impulse responses \hat{R}ᵢ(y).

3. The method of clam 2, wherein a set of convolution kernels is generated from the set of impulse responses.

4. A method of demosaicing a mosaic image, the method comprising convolving the filter kernels of claim 3 with pixel values of the mosaic image.

5. The method of claim 4, wherein an output signal Sₒᵤₜ(x) is calculated from a set of N filter kernels Hᵢ(k) as
$${s}_{out} ( y ) = {\sum }_{k} {s}_{in} ( y - k ) {H}_{g ( y )} ( k ) .$$

6. A digital camera comprising memory storing the filter kernels of claim 3.

7. Computer memory encoded with the filter kernels of claim 3.

8. The method of claim 1, wherein the algorithm is a demosaicing algorithm.

9. The method of claim 1, wherein the image processing includes demosaicing and post processing.

10. The method of claim 1, wherein the set of filter kernels is generated by
applying impulse inputs at a plurality of position indices of the algorithm;
determining responses to the impulse inputs; and
constructing the filter kernels from the impulse inputs.

11. Apparatus for generating filter kernels from an image processing algorithm, the apparatus comprising a processor for generating the kernels by treating the algorithm as block-shift invariant.

12. The apparatus of claim 11, wherein the block-shift invariant algorithm is characterized by a set of impulse responses \hat{R}ᵢ(y).

13. The apparatus of clam 12, wherein a set of convolution kernels is generated from the set of impulse responses.

14. The apparatus of claim 11, wherein the filter kernels are generated by
applying impulse inputs at a plurality of position indices of the algorithm;
determining responses to the impulse inputs; and
constructing the filter kernels from the impulse inputs.

15. An article for causing a processor to generate filter kernels from an image processing algorithm, the article comprising computer memory encoded with a program for generating the kernels by treating the algorithm as block-shift invariant.

16. The article of claim 15, wherein the block-shift invariant algorithm is characterized by a set of impulse responses \hat{R}ᵢ(y).

17. The article of clam 16, wherein a set of convolution kernels is generated from the set of impulse responses.

18. The article of claim 15, wherein the filter kernels are generated by
applying impulse inputs at a plurality of position indices of the algorithm;
determining responses to the impulse inputs; and
constructing the filter kernels from the impulse inputs.

19. A digital imaging system comprising
a photosensor array including a plurality of repetitive cells of photosensors, each cell sensing less than full color at each location;
memory storing a plurality of filter kernels, the filter kernels generated from a demosaicing algorithm that treated the algorithm as block-shift invariant; and
a processor for performing convolving the filter kernels with outputs signals from the photosensor array.

20. The system of claim 19, wherein an output signal Sₒᵤₜ(x) is calculated from a set of N filter kernels Hᵢ(k) as
$${s}_{out} ( y ) = {\sum }_{k} {s}_{in} ( y - k ) {H}_{g ( y )} ( k ) .$$

21. The system of claim 19, wherein the system is a digital camera.
